(19) United States
(12) Patent Application Publication
(10) Pub. No.: US 2026/0291765 A1
(43) Pub. Date: Sep. 24, 2026

(54) METHOD, APPARATUS, DEVICE, AND STORAGE MEDIUM FOR INTERACTION

(71) Applicant: Beijing Zitiao Network Technology Co., Ltd., Beijing (CN)

(72) Inventor: Chuyi WU, Beijing (CN)

(21) Appl. No.: 19/469,880

(22) PCT Filed: May 18, 2024
(86) PCT No.: PCT/CN2024/094095

§ 371 Date: Sep. 26, 2025

(30) Foreign Application Priority Data
Jul. 31, 2023 (CN) 202310952548.5

(51) Int. Cl. H04L 12/18; G06F 3/04842

(52) U.S. Cl. CPC H04L 12/1822; G06F 3/04842

(57) ABSTRACT

According to embodiments of the disclosure, a method, apparatus, device and computer-readable storage medium for interaction are provided. In the method for interaction, an invitation is sent, based on an invitation operation by a first user at a first terminal, to join a target interaction event to a second terminal associated with a second user; a first join control is presented at the first terminal in response to a confirmation by the second user for the invitation, wherein the second terminal also presents a second join control in response to the confirmation; and the first user and the second user are associated with the target interaction event based on a first operation by the first user on the first join control and a second operation by the second user on the second join control.

This application claims priority to Chinese Patent Application No. 202310952548.5, filed on Jul. 31, 2023, and entitled “METHOD, APPARATUS, DEVICE, AND STORAGE MEDIUM FOR INTERACTION”, which is incorporated herein by reference in its entirety.

### FIELD

Example embodiments of the present disclosure generally relate to the field of computer, and in particular, to a method, apparatus, device and computer-readable storage medium for interaction.

### BACKGROUND

With the development of computer technology, people may make invitations and interactions more conveniently. For example, in a multi-player game, a user may use a network connection to invite other users to explore a virtual world together. Such technology enables people to better cooperate and communicate, and create richer and more interactive digital experiences.

### SUMMARY

In a first aspect of the present disclosure, a method for interaction is provided. The method includes: sending, based on an invitation operation by a first user at a first terminal, an invitation to join a target interaction event to a second terminal associated with a second user; presenting a first join control at the first terminal in response to a confirmation by the second user for the invitation, where the second terminal also presents a second join control in response to the confirmation; and associating the first user and the second user with the target interaction event based on a first operation by the first user on the first join control and a second operation by the second user on the second join control.

In a second aspect of the present disclosure, an apparatus for interaction is provided. The apparatus includes: a sending module configured to send, based on an invitation operation by a first user at a first terminal, an invitation to join a target interaction event to a second terminal associated with a second user; a presenting module configured to present a first join control at the first terminal in response to a confirmation by the second user for the invitation, where the second terminal also presents a second join control in response to the confirmation; and an associating module configured to associate the first user and the second user with the target interaction event based on a first operation by the first user on the first join control and a second operation by the second user on the second join control.

In a third aspect of the present disclosure, an electronic device is provided. The device includes at least one processing unit; and at least one memory coupled to the at least one processing unit and storing instructions for execution by the at least one processing unit, the instructions, when executed by the at least one processing unit, causing the electronic device to perform the method the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in this section is not intended to limit the key or important features of the embodiments of the present disclosure, nor is it intended to limit the scope of the present disclosure. Other features of the present disclosure will become readily understandable through the following description.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numerals refer to the same or similar elements, where:

FIG. 1 illustrates a schematic diagram of an example environment in which embodiments of the present disclosure may be implemented;

FIG. 2A to FIG. 2E illustrate schematic diagrams of a plurality of examples of invitation operations according to some embodiments of the present disclosure;

FIG. 3A to FIG. 3E illustrate schematic diagrams of a plurality of examples of joining a virtual interactive scene according to some embodiments of the present disclosure;

FIG. 4 illustrates a flowchart of a method for interaction according to some embodiments of the present disclosure;

FIG. 5 illustrates a block diagram of an apparatus for interaction according to some embodiments of the present disclosure; and

FIG. 6 illustrates a block diagram of a device capable of implementing a plurality of embodiments of the present disclosure.

### DETAILED DESCRIPTION OF EMBODIMENTS

It would be appreciated that, before using the technical solutions disclosed in various embodiments of the present disclosure, the user would be informed of and grant authorization for the type, use scope, use scene, etc. of personal information involved in the present disclosure in an appropriate manner in accordance with relevant laws and regulations.

For example, in response to receiving an active request from the user, prompt information is sent to the user to explicitly prompt the user that the operation requested to be performed will require the obtaining and use of the user's personal information. In this way, the user may independently select whether to provide personal information to software or hardware, such as an electronic device, an application, a server or a storage medium, that performs the operation of the technical solution of the present disclosure, according to the prompt information.

As an optional but non-limiting implementation, the method for sending the prompt information to the user in response to receiving the active request from the user may be, for example, a pop-up window, and the prompt information may be presented in the pop-up window in the form of text. In addition, the pop-up window may also carry a selection control for the user to select to “agree” or “disagree” to provide personal information to the electronic device.

It would be appreciated that the above process of notifying and obtaining user authorization is only illustrative, and does not constitute a limitation to the implementations of the present disclosure. Other manners that satisfy relevant laws and regulations may also be applied to the implementations of the present disclosure.

It would be appreciated that data involved in the technical solution (including but not limited to the data itself, the obtaining or use of the data) would comply with the requirements of corresponding laws and regulations and related provisions.

As used herein, the term “in response to” indicates a status in which a corresponding event occurs or a condition is satisfied. It will be appreciated that the execution timing of a subsequent action performed in response to the event or condition is not necessarily strongly related to the time at which the event occurs or the condition is satisfied. For example, in some cases, the subsequent action may be performed immediately when the event occurs or the condition is satisfied; while in other cases, the subsequent action may be performed after a period of time after the event occurs, or the condition is satisfied.

Embodiments of the present disclosure will be described in more detail below with reference to the drawings. Although some embodiments of the present disclosure are shown in the drawings, it would be appreciated that the present disclosure may be implemented in various forms, and would not be interpreted as being limited to the embodiments set forth herein. On the contrary, these embodiments are provided for a more thorough and complete understanding of the present disclosure. It would be appreciated that the drawings and embodiments of the present disclosure are only for example purposes, and are not intended to limit the scope of protection of the present disclosure.

It would be noted that the titles of any sections/subsections provided herein are not limiting. Various embodiments are described throughout this text, and any type of embodiments may be included under any section/subsection. In addition, embodiments described in any section/subsection may be combined in any manner with any other embodiments described in the same section/subsection and/or different sections/subsections.

In the description of the embodiments of the present disclosure, the term “include” and similar terms would be appreciated as open-ended inclusions, that is, “include but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first”, “second”, etc. may refer to different or same objects. Other explicit and implicit definitions may also be included below.

As used herein, the term “model” may learn the association between a corresponding input and output from training data, so that after the training is completed, a corresponding output may be generated for a given input. The generation of the model may be based on the machine learning technology. Deep learning is a machine learning algorithm that processes inputs and provides corresponding outputs using a multi-layer processing unit. Herein, “model” may also be referred to as “machine learning model”, “machine learning network” or “network”, which terms are used interchangeably herein. One model may in turn include different types of processing units or networks.

As used herein, “unit”, “operation unit” or “sub-unit” may consist of a machine learning model or network of any suitable structure. As used herein, a set of elements or similar expressions may include one or more such elements. For example, “a set of convolution units” may include one or more convolution units.

As briefly mentioned above, a user may invite other users to participate in a certain interaction event, such as a social game. In such an interaction event, the user has a strong desire to “participate with friends”. Some applications support users to interact with other users and enter the same room to play in the form of room invitation or follow-room invitation. For example, if a current user wants to invite a friend to enter a game room together, the user may only invite the friend to enter the room by sending a room invitation link asynchronously, or by initiating a request to enter the room to the person in the room. After the application is approved, the user clicks on the received invitation link and then enters the room.

Due to the asynchronous nature of the invitation, there is a high probability of a technical delay as well as a delay in the response behavior of the user. For example, the invitation initiator needs to wait in the room for the invitee to join, which cannot satisfy the immediacy of participation and increases the anxiety of waiting.

In some applications, a user may send room invitation links to a plurality of users at the same time, and a user may also receive a plurality of room invitation links at the same time. However, because a user may only keep an appointment with one room at a time, other invitations have to be declined. Since the invitation initiator does not know when the invitee will accept the invitation, the invitation initiator has to wait indefinitely, which increases the anxiety of waiting and reduces the success rate of invitation.

In other applications, after a room invitation is sent, the invitation link may remain valid for a long period of time (for example, 30 minutes). The invitee may enter the room at any time. However, both the invitation initiator and the invitee cannot know each other's invitation acceptance status. The user who enters the room first may only wait all the time, and such an invitation method loses immediacy.

In addition, these applications only support one mode, that is, inviting the other party to a pre-selected room. The entire invitation experience is fixed. Moreover, the invitation information is read and matched by the system, lacking personalized content. Such an invitation lacks interestingness.

Therefore, embodiments of the present disclosure provide a solution for interaction. According to various embodiments of the present disclosure, an invitation is sent, based on an invitation operation by a first user at a first terminal, to join a target interaction event to a second terminal associated with a second user; a first join control is presented at the first terminal in response to a confirmation by the second user for the invitation, where the second terminal also presents a second join control in response to the confirmation; and the first user and the second user are associated with the target interaction event based on a first operation by the first user on the first join control and a second operation by the second user on the second join control.

In this way, the embodiments of the present disclosure may support the invitation initiator and the invitee to synchronously join the interaction event through secondary confirmation. In this manner, there is no need for one party to wait, thereby reducing the anxiety of waiting, and further improving the interaction experience of the user.

Example embodiments of the present disclosure will be described below with reference to the drawings.

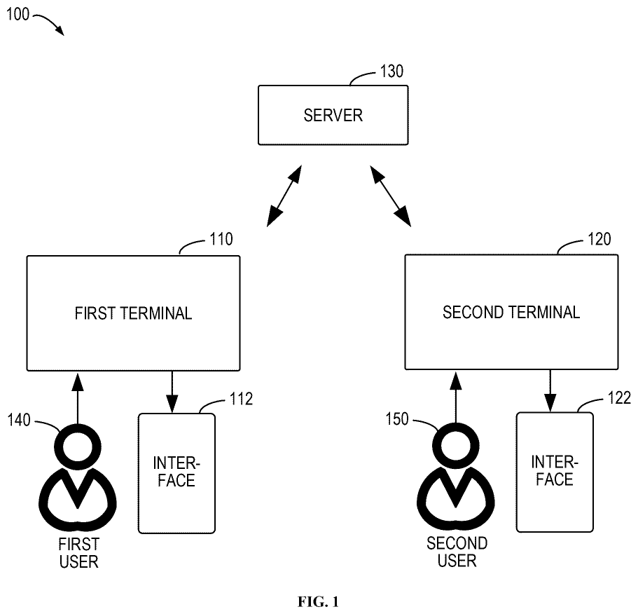

FIG. 1 illustrates a schematic diagram of an example environment 100 in which embodiments of the present disclosure may be implemented. In the environment 100, a server 130 may communicate with a first terminal 110 and a second terminal 120 to present an interface 112 on the first terminal 110 and present an interface 122 on the second terminal 120. The interface 112 and the interface 122 may include interactive interfaces between a first user 140 and a second user 150, such as a session interface, an interface related to an interaction event, and so on.

The first user 140 may establish a session, participate in an interaction event, etc. with the second user 150 via the first terminal 110 and/or an attachment device of the first terminal 110. Correspondingly, the second user 150 may establish a session, participate in an interaction event, etc. with the first user 140 via the second terminal 120 and/or an attachment device of the second terminal 120.

The interaction event includes, but is not limited to, behaviors occurring on platforms such as social media, online games, chat applications, and office applications. For example, the process of forming a team to complete tasks or engage in competitive battles in a multi-player game. For a further example, in a collaboration tool and a shared document platform, users perform operations such as real-time editing and feedback to collaboratively complete a project task. Through these interaction events, users may establish connections and exchange information with each other.

The first terminal 110 may be any type of mobile terminal, stationary terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device or any combination thereof, including accessories and peripherals of these devices or any combination thereof. In some embodiments, the first terminal 110 may also support any type of interface (such as “wearable” circuit, etc.) for the first user 140.

The second terminal 120 may be any type of mobile terminal, stationary terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device or any combination thereof, including accessories and peripherals of these devices or any combination thereof. In some embodiments, the second terminal 120 may also support any type of interface (such as “wearable” circuit, etc.) for the second user 150.

The server 130 may be various types of computing systems/servers capable of providing computing power, including but not limited to a mainframe, an edge computing node, a computing device in a cloud environment, and so on. Although only one server 130 is shown in FIG. 1, the environment 100 may include a plurality of servers 130. For example, one server 130 is configured to present a session interface, and a further server 130 is configured to provide an interaction event to the first user 140 and the second user 150. It would be appreciated that this is only an example description and does not imply any limitation to the scope of the present disclosure.

The solution of the present disclosure aims to solve the need of users to participate in interaction events immediately and together. According to various embodiments of the present disclosure, the user as the initiator is allowed to send an invitation. After the user as the recipient accepts the invitation, both parties need to perform a join operation to successfully participate in the interaction event, thereby improving the success rate of synchronous participation.

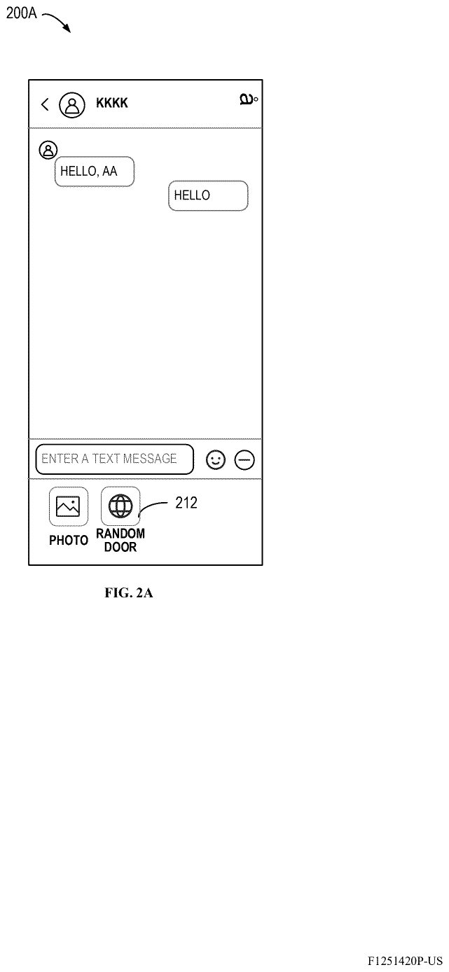

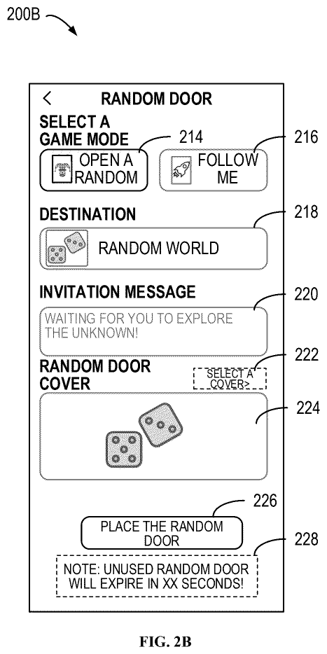

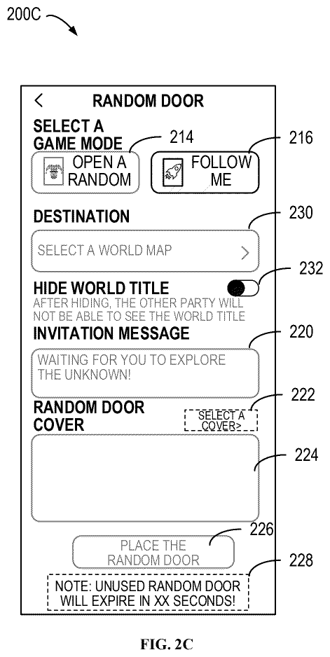

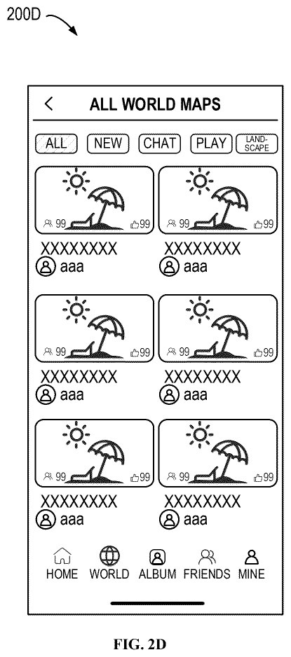

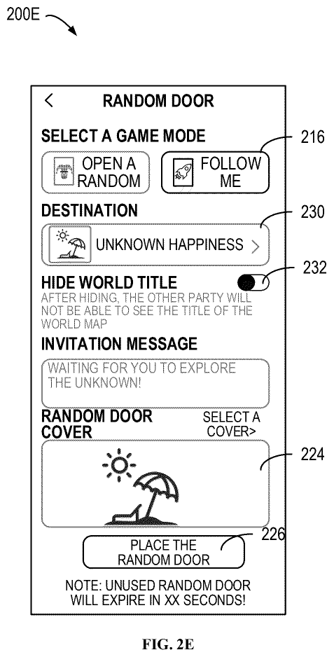

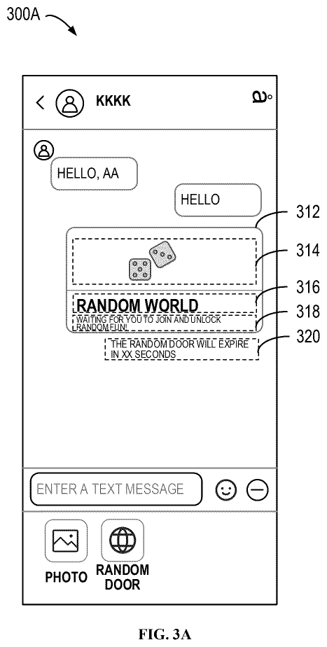

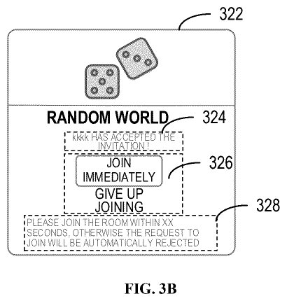

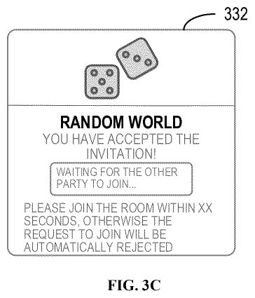

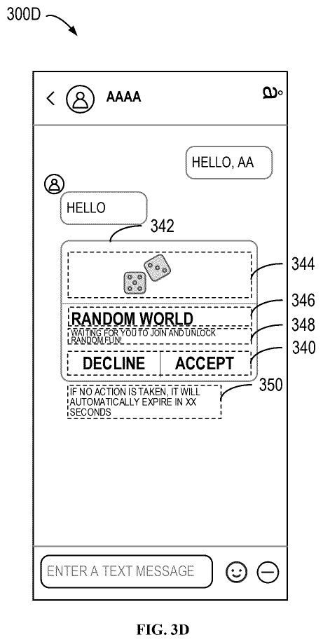

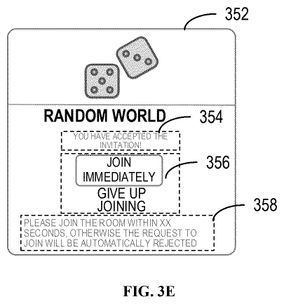

To more clearly understand the embodiments of the present disclosure, taking the first user 140 inviting the second user 150 to join a virtual interaction event in a virtual scene as an example, the following first describes how the first user 140 performs an invitation operation with reference to FIG. 2A to FIG. 2E, and then describes how the first user 140 and the second user 150 synchronously join the virtual interaction event in the virtual environment with reference to FIG. 3A to FIG. 3E. However, it would be appreciated that this is only example, and is not intended to limit the solution of the present disclosure. The embodiments of the present disclosure are applicable to any suitable type of interaction event.

FIG. 2A to FIG. 2E illustrate schematic diagrams of example interfaces 200A to 200E for invitation operations according to some embodiments of the present disclosure. The server 130 may present the example interfaces 200A to 200E to the first user 140 at the first terminal 110. The first user 140 may initiate an invitation operation through these example interfaces. In some embodiments, the invitation operation may indicate a virtual scene (also referred to as a target virtual scene) of the virtual interaction event. Such a virtual scene is, for example, a game room for interaction on a game platform or a specific location scene in a virtual world (for example, a game dungeon scene), and the like. The first user 140 may invite the second user 150 to join such a virtual scene to complete a specific interaction in the virtual scene.

In the example of FIG. 2A, the server 130 presents a session interface to the first user 140 through an appropriate application. Such a session interface may include a private chat interface. For example, in this session interface, the first user 140 may have a one-to-one chat with the second user 150. In some embodiments, the session interface may include a group chat interface. Such a group chat interface may be associated with a plurality of session participants. For example, in this session interface, the first user 140 may have a one-to-many chat with a plurality of users including the second user 150.

In the example of FIG. 2A, the session interface includes a control 212. The name of the control 212 is, for example, “Random door”. The server 130 may receive a click operation of the first user 140 on the control 212 to present a setting interface for the invitation operation.

In some embodiments, the target virtual scene includes a random virtual scene. In the examples of FIG. 2B and FIG. 2C, the setting interface includes a control 214. The name of the control 214 is, for example, “Open a RANDOM”. The server 130 may receive a click operation of the first user 140 on the control 214 to present an interface element corresponding to a random mode. The first user 140 may invite the second user 150 to join the random virtual scene by setting these interface elements. Additionally or in addition, the server 130 may present an interface element corresponding to the random mode in the setting interface by default.

In the example of FIG. 2B, the server 130 presents a setting interface corresponding to the random mode to the first user 140. Such a setting interface also includes an interface element 218. The name of the interface element 218 is, for example, “Destination”. The interface element 218 is configured to present scene information of the random virtual scene. In some embodiments, the server 130 hides scene information of a random virtual scene from the first user 140. For example, the interface element 218 does not display the name of a specific virtual scene but uniformly displays the name “Random World”. Additionally or in addition, when the server 130 sends an invitation to the second user 150 based on such an invitation operation, the scene information of the random virtual scene may also be hidden from the second user 150. In this way, the mystery and interestingness of participation may be increased.

Continuing to refer to the example of FIG. 2B, such a setting interface also includes an interface element 220. The interface element 220 is, for example, a text box named “Invitation Message”. The interface element 220 may be a blank text box by default to support the first user 140 to input a text (also referred to as a first text) about invitation information. The interface element 220 may also present a predetermined text (also referred to as a second text) by default, for example, “Waiting for you to explore the unknown!”. After the first user 140 clicks, a personalized text content may be input. Additionally or in addition, the first text and/or the second text support input of no more than a predetermined number of characters, for example, 50 characters.

Continuing to refer to the example of FIG. 2B, such a setting interface also includes a control 222 and an interface element 224. The control 222 is configured to support the first user 140 to upload images from a default image library, a local image library, or by invoking a camera to take pictures. The interface element 224 is, for example, named “Random door Cover”. The interface element 224 may present a corresponding image based on the random virtual scene or based on the selection of the first user 140. Additionally or in addition, the interface element 224 may support the first user 140 to crop the image with a custom size. When the server 130 sends an invitation to the second user 150, such an image may be used as a cover image of the invitation information.

In the example of FIG. 2B, such a setting interface also includes a control 226 (also referred to as an invitation control) and an interface element 228. The control 226 is, for example, a button named “Place the Random door”. The server 130 may receive a click operation of the first user 140 on the control 226 to send an invitation to the second user 150. The interface element 228 is configured to prompt the first user 140 about the valid time (for example, 10 seconds) of the invitation. For example, the interface element 228 displays “Note: Unused Random door will expire in XX seconds!”. The server 130 may attach such an effective time when sending an invitation to the second user 150. In this way, the user may be reminded to accept the invitation in time, reducing the waiting time of one party, thereby increasing the immediacy of joining the interaction event. Additionally or in addition, such a setting interface may also include a control (not shown) for setting a valid time.

In some embodiments, the target virtual scene includes a virtual scene selected by the first user 140. In the examples of FIG. 2B and FIG. 2C, the setting interface includes a control 216. The name of the control 216 is, for example, “Follow Me”. The server 130 may receive a click operation of the first user 140 on the control 216 to present an interface element corresponding to a selection mode. The first user 140 may invite the second user 150 to join the virtual scene selected by the first user 140 by setting these interface elements. Additionally or in addition, the server 130 may present an interface element corresponding to the selection mode in the setting interface by default.

In the example of FIG. 2C, the server 130 presents a setting interface corresponding to a selection mode to the first user 140. Such a setting interface also includes the interface element 220, the control 222, the interface element 224, the control 226, and the interface element 228. Reference may be made to the description of FIG. 2B for the functions of these interface elements and controls. The setting interface further includes a control 230 and a control 232. The name of the control 230 is, for example, “Destination”. The control 230 is configured to support the first user 140 to select a world map and present scene information of a corresponding virtual scene. The control 232 is, for example, a setting option named “Hide World Title”. The control 232 is configured to control whether scene information of the virtual scene corresponding to the selected world map is hidden from the second user 150. Additionally or in addition, the control 232 also includes prompt information, for example, “After hiding, the other party will not be able to see the world title”. After receiving the operation of the first user 140 to hide the scene information, the server 130 may hide or replace the title of the world map in the control 230, for example, display “Unknown Happiness”. In this way, the mystery and interestingness of participation may be increased.

In some embodiments, the server 130 receives a click operation of the first user 140 on the control 230 to present an example interface 200D. The example interface 200D includes a plurality of world maps. The first user 140 may perform operations such as filtering, searching, switching, collecting, liking, and commenting through corresponding interface elements. The server 130 may, upon receiving a join operation from the first user 140 and the second user 150, instead associate the two users to a selected world map. Such a world map may indicate a virtual town or a virtual shopping mall. The two users may interact in such a virtual scene.

Additionally or in addition, the server 130 may create a virtual interactive room corresponding to the target interaction event. For example, based on the world map selected by the first user 140, the server 130 may create a new virtual interactive room in a virtual scene corresponding to the world map.

In the example of FIG. 2E, the server 130 receives a selection of the world map by the first user 140, presents the scene information of the corresponding virtual scene in the control 230, and presents the corresponding cover image in the interface element 224.

The first user 140 completes the invitation operation through the example interface 200A to 200E. Such an invitation operation includes the process of clicking on the control 212 in the session interface to enter a setting interface for setup, and clicking on the control 226 to send an invitation after the setup is completed. Such an invitation operation supports a random mode and a selection mode. In the random mode, users are allowed to explore the unknown world together, thereby enriching the invitation experience of the users; in the selection mode, the initiator is allowed to select a destination and the name of the destination may be hidden from the invitee, satisfying the need of the users to create surprises, thereby increasing the enthusiasm and interestingness of invitation and appointment.

The server 130 receives the invitation operation initiated by the first user 140 at the first terminal 110, and sends an invitation to the second user 150 at the second terminal 120. Such an invitation indicates that the first user 140 expects to synchronously join the virtual interactive scene with the second user 150 for interaction, such as joining a game room to battle against each other, controlling a game character to a specific scene to do a task, and so on.

In some embodiments, the server 130 creates a virtual interactive room corresponding to the target interaction event, based on the invitation operation by the first user 140 at the first terminal 110. However, the server 130 needs to confirm that the second user 150 accepts the invitation, and after both the first user 140 and the second user 150 agree to join the target interaction event, the two users are added to the virtual interactive room. In this way, the effect of synchronous participation of the invitation initiator and the invitee may be achieved through secondary confirmation. In this manner, there is no need for one party to wait, thereby reducing the anxiety of waiting. This will be further described below with reference to FIG. 3A to FIG. 3B.

FIG. 3A to FIG. 3E illustrate schematic diagrams of example interfaces 300A to 300E for joining a virtual interactive scene according to some embodiments of the present disclosure. In some embodiments, the server 130 presents, in response to the first user 140 sending the invitation to the second user 150, the corresponding invitation information in the session interface. For example, in the example of FIG. 3A, such invitation information is presented as a card-style interface element 312 at the first terminal 110. For a further example, in the example of FIG. 3D, such invitation information is presented as a card-style control 342 at the second terminal 120.

In some embodiments, the invitation information may present an image (also referred to as a target image) associated with the target interaction event. Such a target image may be an image determined based on the virtual scene or an image uploaded by the first user 140. For example, in the example of FIG. 3A, the interface element 312 includes an image 314. The image 314 corresponds to an image in the interface element 224 in the example interface 200B. For a further example, in the example of FIG. 3D, the control 342 includes an image 344. The image 344 corresponds to an image in the interface element 224 in the example interface 200B.

In some embodiments, the invitation information may also present scene information of the virtual interactive scene. Such scene information may be information related to the random virtual scene or the virtual scene selected by the first user 140. For example, in the example of FIG. 3A, the interface element 312 includes information 316 of the virtual scene. The information 316 corresponds to the title in the interface element 218 in the example interface 200B. For a further example, in the example of FIG. 3D, the control 342 includes information 346 of the virtual scene. The information 346 corresponds to the title in the interface element 218 in the example interface 200B.

In some embodiments, the invitation information may also present a target text. Such a target text may be a predetermined text or a text input by the first user 140. For example, in the example of FIG. 3A, the interface element 312 includes a text 318. The text 318 corresponds to an invitation message in the interface element 220 in the example interface 200B. For a further example, in the example of FIG. 3D, the control 342 includes a text 348. The text 348 corresponds to an invitation message in the interface element 220 in the example interface 200B.

In some embodiments, the invitation information may also present information about a valid time of an invitation. For example, in the example of FIG. 3A, the interface element 312 includes information 320. The information 320 may present information including a countdown, for example, “The Random door will expire in XX seconds”. Such information may count down from the valid time in the interface element 228 in the example interface 200B to 0. For a further example, in the example of FIG. 3D, the control 342 includes information 350. The information 350 may present information including a countdown, for example, “Please join the room within XX seconds, otherwise the request to join will be automatically declined”. Such information may count down from the valid time in the interface element 228 in the example interface 200B to 0.

In the example of FIG. 3D, the control 342 presented by the server 130 to the second user 150 may also include sub-controls 340 for agreeing to the invitation and declining the invitation. If the second user 150 accepts the invitation, the server 130 presents a join control 322 (also referred to as a first join control) at the first terminal 110, and presents a join control 352 (also referred to as a second join control) at the second terminal 120. Further, the server 130 enables the first user 140 and the second user 150 to synchronously join the target interaction event based on an operation by the first user 140 on the join control 322 and an operation by the second user 150 on the join control 352.

Synchronously joining the target interaction event may be joining at the same moment. For example, the first user 140 and the second user 150 simultaneously confirm joining the virtual interactive room within the valid time of the random door, or jointly join the virtual interactive room after both parties confirm. In some embodiments, synchronously joining the target interaction event may also be joining at similar moments. For example, the first user 140 confirms and joins the virtual interactive room first at a first moment within the valid time of the random door, and the second user 150 confirms and subsequently joins the virtual interactive room at a second moment within the valid time of the random door. Since the valid time of the random door is set to be a very short period of time, the waiting time of the user who enters the virtual interactive room first may be almost negligible, thereby achieving the effect of timeliness as well.

In some embodiments, referring to the example of FIG. 3B, the join control 322 may include a sub-control 326. The sub-control 326 is configured to receive an operation of the first user 140 of agreeing to join the target interaction event (also referred to as a first operation) or an operation of the first user 140 of giving up joining the target interaction event (also referred to as a third operation).

In some embodiments, referring to the example of FIG. 3E, the join control 352 may include a sub-control 356. The sub-control 356 is configured to receive an operation of the second user 150 of agreeing to join the target interaction event (also referred to as a second operation) or an operation of the second user 150 of giving up joining the target interaction event (also referred to as a fourth operation).

In some embodiments, referring to the example of FIG. 3B, the join control 322 may also include an interface element 324. The interface element 324 is configured to present status information of the join control 352. Such status information indicates that the second user 150 has accepted the invitation. For example, the interface element 324 displays “KKKK has accepted the invitation!” (KKKK represents the nickname of the second user 150). In this way, the first user 140 may be informed of the invitation acceptance status of the second user 150, and the first user 140 may be reminded to join the interaction event in time. Additionally or in addition, referring to the example of FIG. 3E, the join control 352 may include an interface element 354. The interface element 354 is configured to present status information of the join control 352. Such status information indicates that the second user 150 has accepted the invitation. For example, the interface element 354 displays “You have accepted the invitation!”.

In some embodiments, referring to the example of FIG. 3B, the join control 322 may include an interface element 328. The interface element 328 is configured to present information including a countdown (also referred to as a first countdown), for example, “Please join the room within XX seconds, otherwise the request to join will be automatically declined”. Additionally or in addition, referring to the example of FIG. 3E, the join control 352 may include an interface element 358. The interface element 358 is configured to present information including a countdown (also referred to as a second countdown), for example, “Please join the room within XX seconds, otherwise the request to join will be automatically declined”.

In some embodiments, referring to the example of FIG. 3C, If the server 130 receives an operation from the first user 140 agreeing to join the target interaction event before the end of the first countdown, the reminder control 332 about waiting to join the target interaction event is presented. The reminder control 332 includes, for example, a prompt message such as “You have accepted the invitation!”, “Waiting for the other party to join . . . ”, and the like. In this way, waiting anxiety of the user who first agrees to join the target interaction event can be effectively reduced.

In some embodiments, if the server 130 does not receive an operation from the first user 140 agreeing to join the target interaction event before the end of the first countdown, a reminder about the failure to join the target interaction event is presented (also referred to as a first reminder). For example, if the first user 140 times out, the first user 140 defaults to declining to join the target interaction event. The server 130 presents a reminder of “You have given up joining the room” to the first user 140, and presents a reminder of “The other party has given up joining the room” to the second user 150.

In some embodiments, the server 130 may determine that the first countdown ends or the receipt of an operation (also referred to as a third operation) of the first user 140 abandoning to join the target interaction event for the join control 322, causing the second terminal 120 to present a reminder (also referred to as a second reminder) about the abandonment of the join target interaction event by the first user 140. Additionally or in addition, the server 130 may determine that the end of the second countdown or the receipt of an operation (also referred to as a fourth operation) of the second user 150 abandoning to join the target interaction event for the join control 352, causing the first terminal 110 to present a reminder (also referred to as a third reminder) about the abandonment of the join target interaction event by the second user 150.

For example, if both the first user 140 and the second user 150 have exceeded the time limit, the server 130 presents a reminder of “the random door has been invalidated” to the first user 140 and the second user 150, respectively. For example, if the first user 140 agrees to join the target interaction event, but the second user 150 gives up joining the target interaction event, the server 130 presents a reminder of “the other party has declined the invitation to join the room” to the first user 140, and presents a reminder of “the random door has expired” to the second user 150.

Additionally or in addition, the join control 322, the join control 352, and the reminder control 332 may also present an image associated with the target interaction event and scene information of the virtual interactive scene.

In some embodiments, when presenting one or more of the join control 322, the join control 352, or the reminder control 332, the server 130 may prevent other interactive operations, for example, notify the first user 140 and the second user 150 through a full-screen pop-up window, so that the first user 140 and the second user 150 focus on these controls and confirm whether to join the target interaction event as soon as possible. In this way, the anxiety of waiting may be effectively reduced.

In some embodiments, the server 130 determines, based on an execution status of a historical invitation created by the first user 140, whether to enable an operating privilege of the first user 140 to initiate the invitation operation. If there is no ongoing invitation currently, the first user 140 may initiate the invitation operation; if there is an ongoing invitation currently, the first user 140 may not initiate a further invitation operation. In this way, it is ensured that a user may only initiate an invitation operation to one friend at a time, and a further invitation operation may only be initiated after the invitation operation expires. In this way, the success rate of users participating together may be improved.

In conclusion, according to various embodiments of the present disclosure, after the first user 140 initiates the invitation operation, the server 130 needs the first user 140 and the second user 150 to perform secondary confirmation before synchronously adding both parties to the interaction event, without waiting for one party. In this way, the situation where the user waits unilaterally may be avoided, thereby improving the interaction experience of the user.

### Example Process

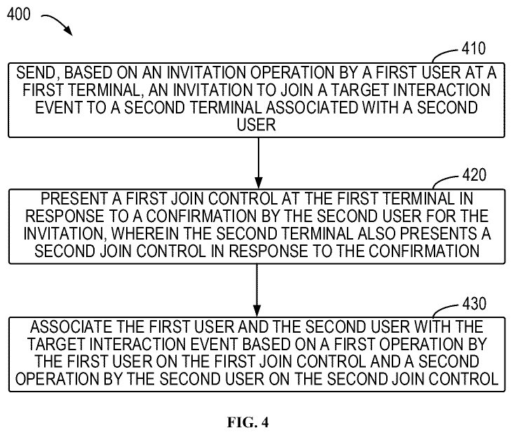

FIG. 4 illustrates a flowchart of a method 400 for interaction according to some embodiments of the present disclosure. The method 400 may be implemented on the server 130. The method 400 will be described below with reference to FIG. 1.

At block 410, the server 130 sends, based on an invitation operation by a first user at a first terminal, an invitation to join a target interaction event to a second terminal associated with a second user. At block 420, a first join control is presented at the first terminal in response to a confirmation by the second user for the invitation, where the second terminal also presents a second join control in response to the confirmation. At block 430, the first user and the second user are associated with the target interaction event based on a first operation by the first user on the first join control and a second operation by the second user on the second join control.

In some embodiments, the server 130 presents a session interface between the first user and the second user, the session interface including an invitation control; and receives the invitation operation based on a selection by the first user on the invitation control.

In some embodiments, the server 130 presents an invitation message corresponding to the invitation in the session interface.

In some embodiments, the invitation information presents a target image associated with the target interaction event, the target image including: an image uploaded by the first user; or an image determined based on a virtual scene for the target interaction event.

In some embodiments, the invitation information presents a target text, the target text including: a first text input by the first user; or a predetermined second text.

In some embodiments, the session interface includes a group chat interface, the group chat interface being associated with a plurality of session participants, the plurality of session participants including at least the first user and the second user.

In some embodiments, the invitation operation further indicates a target virtual scene for the target interaction event.

In some embodiments, the target virtual scene includes the target virtual scene selected by the first user.

In some embodiments, the invitation operation further indicates a setting option for the target virtual scene, the setting option being configured to control whether scene information of the target virtual scene is hidden from the second user.

In some embodiments, the target virtual scene further includes a random virtual scene, and before the first user and the second user are associated with the target interaction event, scene information of the random virtual scene is hidden from the first user or the second user.

In some embodiments, the server 130 creates, based on the invitation operation by the first user at the first terminal, a virtual interactive room corresponding to the target interaction event, without adding the first user to the virtual interactive room.

In some embodiments, the server 130 presents a first countdown associated with the first join control; and presents, in response to a failure of receiving the first operation by the first user on the first join control before the first countdown ends, a first reminder about a failure to join the target interaction event.

In some embodiments, the server 130 causes, in response to the first countdown ending or a third operation by the first user on the first join control, the second terminal to present a second reminder about the first user giving up joining the target interaction event, the third operation indicating that the first user gives up joining the target interaction event; or presents, in response to a second countdown of the second join control ending or a fourth operation by the second user on the second join control, a third reminder about the second user giving up joining the target interaction event at the first terminal, the fourth operation indicating that the second user gives up joining the target interaction event.

In some embodiments, the server 130 presents, with the first join control, status information of the second join control, the status information indicating whether the second user initiates the second operation.

In some embodiments, the server 130 determines, based on an execution status of a historical invitation created by the first user, whether to enable an operating privilege for the first user to initiate the invitation operation at the first terminal.

### Example Apparatus and Device

FIG. 5 illustrates a schematic structural block diagram of an apparatus 600 for interaction according to some embodiments of the present disclosure. The apparatus 500 may be implemented or included in the server 130. Various modules/components in the apparatus 500 may be implemented by hardware, software, firmware, or any combination thereof.

As shown in the figure, the apparatus 500 includes a sending module 510 configured to send, based on an invitation operation by a first user at a first terminal, an invitation to join a target interaction event to a second terminal associated with a second user. The apparatus 500 further includes a presenting module 520 configured to present a first join control at the first terminal in response to a confirmation by the second user for the invitation, where the second terminal also presents a second join control in response to the confirmation. The apparatus 500 further includes an associating module 530 configured to associate the first user and the second user with the target interaction event based on a first operation by the first user on the first join control and a second operation by the second user on the second join control.

In some embodiments, the apparatus 500 further includes a session interface presenting module configured to present a session interface between the first user and the second user, the session interface including an invitation control; and an invitation operation receiving module configured to receive the invitation operation based on a selection by the first user on the invitation control.

In some embodiments, the apparatus 500 further includes an invitation message presenting module configured to present an invitation message corresponding to the invitation in the session interface.

In some embodiments, the invitation information presents a target image associated with the target interaction event, the target image including: an image uploaded by the first user; or an image determined based on a virtual scene for the target interaction event.

In some embodiments, the invitation information presents a target text, the target text including: a first text input by the first user; or a predetermined second text.

In some embodiments, the session interface includes a group chat interface, the group chat interface being associated with a plurality of session participants, the plurality of session participants including at least the first user and the second user.

In some embodiments, the invitation operation further indicates a target virtual scene for the target interaction event.

In some embodiments, the target virtual scene includes the target virtual scene selected by the first user.

In some embodiments, the invitation operation further indicates a setting option for the target virtual scene, the setting option being configured to control whether scene information of the target virtual scene is hidden from the second user.

In some embodiments, the target virtual scene further includes a random virtual scene, and before the first user and the second user are associated with the target interaction event, scene information of the random virtual scene is hidden from the first user or the second user.

In some embodiments, the apparatus 500 further includes a creating module configured to create, based on the invitation operation by the first user at the first terminal, a virtual interactive room corresponding to the target interaction event, without adding the first user to the virtual interactive room.

In some embodiments, the apparatus 500 further includes a first countdown presenting module configured to present a first countdown associated with the first join control; and a first reminder presenting module configured to present, in response to a failure of receiving the first operation by the first user on the first join control before the first countdown ends, a first reminder about a failure to join the target interaction event.

In some embodiments, the apparatus 500 further includes a second reminder presenting module configured to cause, in response to the first countdown ending or a third operation by the first user on the first join control, the second terminal to present a second reminder about the first user giving up joining the target interaction event, the third operation indicating that the first user gives up joining the target interaction event; or a third reminder presenting module configured to present, in response to a second countdown of the second join control ending or a fourth operation by the second user on the second join control, a third reminder about the second user giving up joining the target interaction event at the first terminal, the fourth operation indicating that the second user gives up joining the target interaction event.

In some embodiments, the apparatus 500 further includes a status information presenting module configured to present, with the first join control, status information of the second join control, the status information indicating whether the second user initiates the second operation.

In some embodiments, the apparatus 500 further includes an operating privilege determining module configured to determine, based on an execution status of a historical invitation created by the first user, whether to enable an operating privilege for the first user to initiate the invitation operation at the first terminal.

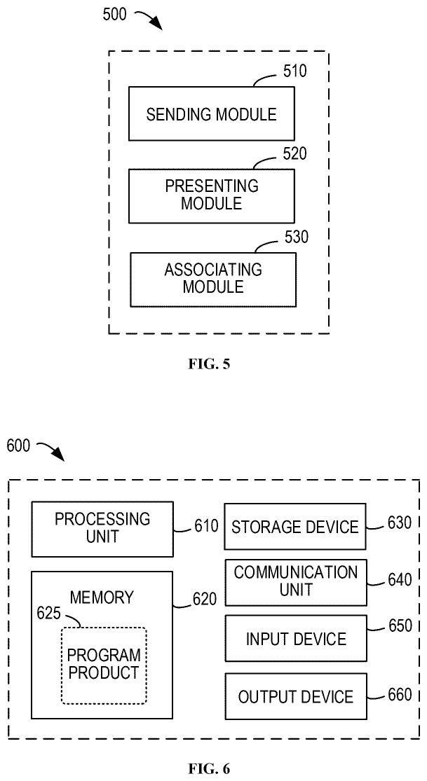

FIG. 6 is a block diagram of an electronic device 600 in which one or more embodiments of the present disclosure can be implemented. It would be appreciated that the electronic device 600 shown in FIG. 6 is only example, and would not constitute any limitation to the function and scope of the embodiments described herein. The electronic device 600 shown in FIG. 6 may be configured to implement the terminal device 110 or the server 130 in FIG. 1.

As shown in FIG. 6, the electronic device 600 is in the form of a general-purpose electronic device. The components of the electronic device 600 may include but are not limited to one or more processors or processing units 610, a memory 620, a storage device 630, one or more communication units 640, one or more input devices 650, and one or more output devices 660. The processing unit 610 may be an actual or virtual processor and may perform various processing according to programs stored in the memory 620. In a multi-processor system, multiple processing units execute computer-executable instructions in parallel to improve the parallel processing capability of the electronic device 600.

The electronic device 600 typically includes multiple computer storage media. Such media may be any available media accessible by the electronic device 600, including but not limited to volatile and non-volatile media, removable and non-removable media. The memory 620 may be a volatile memory (such as a register, a cache, a random access memory (RAM)), a non-volatile memory (such as a read-only memory (ROM), an electrically erasable programmable read-only memory (EEPROM), a flash memory), or some combination thereof. The storage device 630 may be a removable or non-removable medium, and may include a machine-readable medium, such as a flash drive, a disk, or any other medium, which may be configured to store information and/or data and may be accessed within the electronic device 600.

The electronic device 600 may further include additional removable/non-removable, volatile/non-volatile storage media. Although not shown in FIG. 6, a disk drive for reading from or writing to a removable, non-volatile disk (e.g., a “floppy disk”) and an optical disk drive for reading from or writing to a removable, non-volatile optical disk may be provided. In these cases, each drive may be connected to a bus (not shown) by one or more data medium interfaces. The memory 620 may include a computer program product 625 having one or more program modules configured to perform various methods or actions of various embodiments of the present disclosure.

The communication unit 640 enables communication with other electronic devices through communication media. Additionally, the functions of the components of the electronic device 600 may be implemented in a single computing cluster or a plurality of computing machines that can communicate through communication connections. Thus, the electronic device 600 can operate in a networked environment using logical connections to one or more other servers, network personal computers (PCs), or a further network node.

The input device 650 may be one or more input devices, such as a mouse, a keyboard, a trackball, and the like. The output device 660 may be one or more output devices, such as a display, a speaker, a printer, and the like. The electronic device 600 may further communicate with one or more external devices (not shown) such as a storage device, a display device, etc. through the communication unit 640 as needed, communicate with one or more devices that enable the user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to an example implementation of the present disclosure, a computer-readable storage medium is provided, where the computer-readable storage medium has computer-executable instructions stored thereon, where the computer-executable instructions are executed by a processor to implement the above-described method. According to an example implementation of the present disclosure, a computer program product is further provided, where the computer program product is tangibly stored on a non-transitory computer-readable medium and includes computer-executable instructions, and the computer-executable instructions are executed by a processor to implement the above-described method.

Various aspects of the present disclosure are described herein with reference to flowcharts and/or block diagrams of the methods, apparatuses, devices, and computer program products implemented according to the present disclosure. It would be appreciated that each block of the flowcharts and/or block diagrams and combinations of blocks in the flowcharts and/or block diagrams may be implemented by computer-readable program instructions.

These computer-readable program instructions may be provided to a processing unit of a general-purpose computer, a dedicated computer, or other programmable data processing apparatus to produce a machine, so that the instructions, when executed by the processing unit of the computer or other programmable data processing apparatus, produce an apparatus for implementing the functions/actions specified in one or more blocks in the flowcharts and/or block diagrams. These computer-readable program instructions may also be stored in a computer-readable storage medium. These instructions cause the computer, the programmable data processing apparatus, and/or other devices to work in a specific manner, so that the computer-readable medium storing the instructions includes an article of manufacture, which includes instructions for implementing various aspects of the functions/actions specified in one or more blocks in the flowcharts and/or block diagrams.

The computer-readable program instructions may be loaded onto a computer, other programmable data processing apparatus, or other device to cause a series of operations to be performed on the computer, the other programmable data processing apparatus, or the other device to produce a computer-implemented process, such that the instructions executed on the computer, the other programmable data processing apparatus, or the other device implement the functions/actions specified in one or more blocks in the flowcharts and/or block diagrams.

The flowcharts and block diagrams in the drawings illustrate the architecture, functionality, and operation of possible implementations of systems, methods, and computer program products according to a plurality of implementations of the present disclosure. In this regard, each block in the flowcharts or block diagrams may represent a module, a program segment, or a portion of instructions, including one or more executable instructions for implementing specified logical functions. In some alternative implementations, the functions noted in the blocks may also occur out of the order noted in the figures. For example, two blocks shown in succession may, in fact, be executed substantially concurrently, or the blocks may sometimes be executed in a reverse order, depending upon the functionality involved. It is also noted that, each block of the block diagrams and/or flowcharts, and combinations of blocks in the block diagrams and/or flowcharts, may be implemented by special purpose hardware-based systems that perform the specified functions or acts, or combinations of special purpose hardware and computer instructions.

The implementations of the present disclosure have been described above, and the above description is example, not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical application or the improvement of the technology in the market, or to enable others of ordinary skill in the art to understand the implementations disclosed herein.

1. A method of interaction, comprising:
sending, based on an invitation operation by a first user at a first terminal, an invitation to join a target interaction event to a second terminal associated with a second user;
presenting a first join control at the first terminal in response to a confirmation by the second user for the invitation, wherein the second terminal also presents a second join control in response to the confirmation; and
associating the first user and the second user with the target interaction event based on a first operation by the first user on the first join control and a second operation by the second user on the second join control.

2. The method according to claim 1, further comprising:
presenting a session interface between the first user and the second user, the session interface comprising an invitation control; and
receiving the invitation operation based on a selection by the first user on the invitation control.

3. The method according to claim 2, further comprising:
presenting an invitation message corresponding to the invitation in the session interface.

4. The method according to claim 3, wherein the invitation information presents a target image associated with the target interaction event, the target image comprising:
an image uploaded by the first user; or
an image determined based on a virtual scene for the target interaction event.

5. The method according to claim 3, wherein the invitation information presents a target text, the target text comprising:
a first text input by the first user; or
a predetermined second text.

6. The method according to claim 2, wherein the session interface comprises a group chat interface, the group chat interface being associated with a plurality of session participants, the plurality of session participants comprising at least the first user and the second user.

7. The method according to claim 1, wherein the invitation operation further indicates a target virtual scene for the target interaction event.

8. The method according to claim 7, wherein the target virtual scene comprises the target virtual scene selected by the first user.

9. The method according to claim 8, wherein the invitation operation further indicates a setting option for the target virtual scene, the setting option being configured to control whether scene information of the target virtual scene is hidden from the second user.

10. The method according to claim 7, wherein the target virtual scene further comprises a random virtual scene, and
before the first user and the second user are associated with the target interaction event, scene information of the random virtual scene is hidden from the first user or the second user.

11. The method according to claim 1, further comprising:
creating, based on the invitation operation by the first user at the first terminal, a virtual interactive room corresponding to the target interaction event, without adding the first user to the virtual interactive room.

12. The method according to claim 1, further comprising:
presenting a first countdown associated with the first join control; and
presenting, in response to a failure of receiving the first operation by the first user on the first join control before the first countdown ends, a first reminder about a failure to join the target interaction event.

13. The method according to claim 12, further comprising:
causing, in response to the first countdown ending or a third operation by the first user on the first join control, the second terminal to present a second reminder about the first user giving up joining the target interaction event, the third operation indicating that the first user gives up joining the target interaction event; or
presenting, in response to a second countdown of the second join control ending or a fourth operation by the second user on the second join control, a third reminder about the second user giving up joining the target interaction event at the first terminal, the fourth operation indicating that the second user gives up joining the target interaction event.

14. The method according to claim 1, further comprising:
presenting, with the first join control, status information of the second join control, the status information indicating whether the second user initiates the second operation.

15. The method according to claim 1, further comprising:
determining, based on an execution status of a historical invitation created by the first user, whether to enable an operating privilege for the first user to initiate the invitation operation at the first terminal.

16. (canceled)

17. An electronic device, comprising:
at least one processor; and
at least one memory coupled to the at least one processor and storing instructions for execution by the at least one processor, the instructions, when executed by the at least one processor, causing the electronic device to perform operations comprising:
sending, based on an invitation operation by a first user at a first terminal, an invitation to join a target interaction event to a second terminal associated with a second user;
presenting a first join control at the first terminal in response to a confirmation by the second user for the invitation, wherein the second terminal also presents a second join control in response to the confirmation; and
associating the first user and the second user with the target interaction event based on a first operation by the first user on the first join control and a second operation by the second user on the second join control.

18. A non-transitory computer-readable storage medium having a computer program stored thereon, the computer program being executable by a processor to implement operations comprising
sending, based on an invitation operation by a first user at a first terminal, an invitation to join a target interaction event to a second terminal associated with a second user;
presenting a first join control at the first terminal in response to a confirmation by the second user for the invitation, wherein the second terminal also presents a second join control in response to the confirmation; and
associating the first user and the second user with the target interaction event based on a first operation by the first user on the first join control and a second operation by the second user on the second join control.

19. The electronic device according to claim 17, wherein the operations further comprise:
presenting a session interface between the first user and the second user, the session interface comprising an invitation control; and
receiving the invitation operation based on a selection by the first user on the invitation control.

20. The electronic device according to claim 19, wherein the operations further comprise:
presenting an invitation message corresponding to the invitation in the session interface.

21. The electronic device according to claim 20 wherein the invitation information presents a target image associated with the target interaction event, the target image comprising:
an image uploaded by the first user; or
an image determined based on a virtual scene for the target interaction event.
